(19) United States
(12) Patent Application Publication
(10) Pub. No.: US 2020/0349453 A1
(43) Pub. Date: Nov. 5, 2020

(54) METHOD AND SYSTEM FOR SOLVING A DYNAMIC PROGRAMMING PROBLEM

(71) Applicant: 1QB INFORMATION TECHNOLOGIES INC., Vancouver (CA)

(72) Inventor: Pooya RONAGH, Vancouver (CA)

(73) Assignee: 1QB INFORMATION TECHNOLOGIES INC., Vancouver (CA)

(21) Appl. No.: 16/863,502

(22) Filed: Apr. 30, 2020

Related U.S. Application Data
(60) Provisional application No. 62/841,480, filed on May 1, 2019.

(51) Int. Cl. G06N 5/04; G06N 10/00; G06N 20/00

(52) U.S. Cl. CPC G06N 5/04; G06N 20/00; G06N 10/00

(57) ABSTRACT

A method and a system are disclosed for solving a dynamic programming problem using a quantum computer. The method comprises receiving an indication of a dynamic programming problem, the dynamic programming problem comprising a plurality of transition kernels, receiving data representative of the dynamic programming problem, generating at least one oracle for the transition kernels of the dynamic programming problem, until a stopping criterion is met determining at least one linear programming problem for the dynamic programming problem, solving the at least one linear programming problem using a quantum computer comprising the generated at least one oracle to determine at least one solution, and providing the determined at least one solution; and providing a solution to the dynamic programming problem.

### CROSS-REFERENCE TO RELATED APPLICATIONS

This application claims the benefit of U.S. Provisional Patent Application No. 62/841,480, filed May 1, 2019, which is hereby incorporated by reference.

### BACKGROUND OF THE INVENTION

### Dynamic Programming, Reinforcement Learning and Markov Decision Problems

Markov decision processes are useful models for problems solved using dynamic programming (DP) and reinforcement learning (RL). Recently, there has been an increasing interest in developing a method based on quantum algorithms for dynamic programming and reinforcement learning problems. Ambainis, Andris, Kaspars Balodis, Jānis Iraids, Martins Kokainis, Krišjānis Prūsis, and Jevgēnijs Vihrovs. 2019. “Quantum Speedups for Exponential-Time Dynamic Programming Algorithms.” In Proceedings of the Thirtieth Annual Acm-Siam Symposium on Discrete Algorithms, 1783-93. SIAM. (hereinafter Ambainis et al.) study quantum algorithms for a collection of NP-hard problems (e.g. the travelling salesperson problem, and the minimum set cover problem) for which the best classical algorithms are exponentially expensive dynamic programming solutions, namely algorithms where the time to solve the problem is exponential in the number of nodes (see for example Bellmen-Held-Karp method). It is pointed out in Ambainis et al. that achieving a quantum advantage over classical dynamic programming algorithms has been a known problem in the quantum computing community. Ibid however proves an improvement from the exponential time complexity O*(2ⁿ) to O*(1.728ⁿ) for these problems. Here the O* notation hides polynomial factors. Until now achieving a quadratic quantum speedup for solving dynamic programming problems and their generalization to Markov decision problems (MDP) has remained an open challenge. It has been shown in “Quantum algorithms for solving dynamic programming problems” by Pooya Ronagh (https://arxiv.org/pdf/1906.02229.pdf) that any method based on quantum computing cannot achieve better improvement than the quadratic speedup in the number of states and actions.

### Real-World Applications of Reinforcement Learning/Markov Decision Problems and Dynamic Programming

Reinforcement learning and dynamic programming may be used for solving a variety of real-world problems in the fields of, including but not limited to, economics, computer science, traffic, robotics, chemistry, and bioinformatics.

Resources management in computer clusters is one of the common practical challenging problems. Computer clusters are usually deployed to improve performance and availability over that of a single computer, while typically being much more cost-effective than single computers of comparable speed or availability. Designing algorithms to allocate limited resources to different tasks is challenging and requires human-generated heuristics. Reinforcement learning may be used for automatically learning to allocate and schedule computer resources to waiting jobs, with the objective to minimize the average job slowdown.

Another practical problem which may benefit from applying reinforcement learning is a congestion problem in traffic. Reinforcement learning may be used, for instance, for designing a traffic light controller for solving the congestion problem.

Robotics is another technological field which uses reinforcement learning extensively. Reinforcement learning may be used, for instance, for training a robot to learn policies to map raw video images to robot's actions. Other robots with behaviors that were reinforcement learned include, but are not limited to, aerial vehicles, robotic arms, autonomous vehicles, and humanoid robots.

Web system configuration is yet another practical challenging problem which may be formulated in the reinforcement learning framework. There are over than 100 configurable parameters in a web system and the process of tuning the parameters requires a skilled operator and numerous trial-and-error tests. Reinforcement learning may be used, for instance, in the domain on how to do autonomic reconfiguration of parameters in multi-tier web systems in VM-based dynamic environments.

Reinforcement learning may also be applied for optimizing chemical reactions, in cooling systems in data centres, in supply chains management as well as scheduling carrier services.

Another domain which may benefit from applying reinforcement learning is Personalized Recommendations. Previous work of news recommendations faced several challenges including the rapid changing dynamic of news, users getting bored easily and Click Through Rate not reflecting the retention rate of users. Reinforcement learning may be applied in news recommendation system to address the problems.

Reinforcement learning may also be applied in the bidding and advertising field as well as in games.

It will be appreciated that dynamic programming may be broadly applied to many problems in economics, computer science and bioinformatics. The problems may include, but are not limited to, a multi-stage asset allocation problem or a dynamic portfolio problem, an optimal growth problem, the shortest path problem. Dynamic programming is widely used in bioinformatics for tasks such as sequence alignment, protein folding, RNA structure prediction and protein-DNA binding.

In genetics, sequence alignment is an important application where dynamic programming is essential.

There is a need for at least one of a method and a system that will overcome at least one of the above-identified drawbacks.

### BRIEF SUMMARY OF THE INVENTION

According to a broad aspect there is disclosed a method for solving a dynamic programming problem using a quantum computer, the method comprising receiving an indication of a dynamic programming problem, the dynamic programming problem comprising a plurality of transition kernels, receiving data representative of the dynamic programming problem, generating at least one oracle for the transition kernels of the dynamic programming problem, until a stopping criterion is met determining at least one linear programming problem for the dynamic programming problem, solving the at least one linear programming problem using a quantum computer comprising the generated at least one oracle to determine at least one solution, and providing the determined at least one solution; and providing a solution to the dynamic programming problem.

According to one or more embodiments, the data representative of the dynamic programming problem comprises an initial starting state selected from a plurality of all states of the dynamic programming model.

According to one or more embodiments, the solution to the dynamic programming problem comprises the optimal value function at an initial starting state.

According to one or more embodiments, the solution to the dynamic programming problem comprises an optimal policy at the initial starting state.

According to one or more embodiments, the data representative of the dynamic programming problem comprises a finite set of rules describing all allowed transitions of the dynamic programming model from any state to all possible accessible next states.

According to one or more embodiments, the solving of each of the at least one linear programming problems using a quantum computer comprises performing a multiplicative weight update method on the determined at least one linear programming problem.

According to one or more embodiments, said performing of the multiplicative weight update method on the determined at least one linear programming problem comprises solving a second set of linear programming problems, wherein each of the second set of linear programming problem is generated for solving a given one of the at least one linear programming problem.

According to one or more embodiments, the second set of linear programming problems is comprised of linear programming feasibility problems.

According to one or more embodiments, each of the linear programming feasibility problems in a set of linear programming feasibility problems is solved using a quantum minimum finding algorithm on the quantum computer.

According to one or more embodiments, the quantum computer comprises a circuit model quantum processor.

According to one or more embodiments, the quantum computer comprises a quantum annealer.

According to one or more embodiments, the quantum computer comprises a coherent Ising machine comprising a network of optic parametric oscillators.

According to one or more embodiments, the dynamic programming problem comprises a finite horizon dynamic programming problem.

According to one or more embodiments, the dynamic programming problem comprises a Markov decision problem.

According to one or more embodiments, the Markov decision problem comprises an infinite horizon discounted-reward Markov decision problem.

According to one or more embodiments, the Markov decision problem comprises an infinite horizon average-reward Markov decision problem.

According to one or more embodiments, there is disclosed a use of the method disclosed above for solving a multi-period optimization problem.

According to one or more embodiments, the multi-period optimization problem comprises at least one member of a group consisting of a dynamic portfolio problem, an optimal growth problem and a shortest path problem.

According to one or more embodiments, there is disclosed a use of the method disclosed above for solving an optimal control problem.

According to one or more embodiments, the optimal control problem comprises at least one member of a group consisting of a dynamic portfolio problem, an optimal growth problem, and a shortest path problem.

According to a broad aspect, there is disclosed a non-transitory computer readable storage medium is disclosed for storing computer-executable instructions which, when executed, cause a computer to perform a method for solving a dynamic programming problem using a quantum computer, the method comprising receiving an indication of a dynamic programming problem, the dynamic programming problem comprising a plurality of transition kernels, receiving data representative of the dynamic programming problem, generating at least one oracle for the transition kernels of the dynamic programming problem, until a stopping criterion is met: determining at least one linear programming problem for the dynamic programming problem, solving the at least one linear programming problem using a quantum computer comprising the generated at least one oracle to determine at least one solution, and providing the determined at least one solution; and providing a solution to the dynamic programming problem.

According to a broad aspect, there is disclosed a computer comprising a central processing unit; a display device; a communication port; a memory unit comprising an application for solving a dynamic programming problem using a quantum computer, the application comprising, instructions for receiving an indication of a dynamic programming problem, the dynamic programming problem comprising a plurality of transition kernels, instructions for receiving data representative of the dynamic programming problem, instructions for generating at least one oracle for the transition kernels of the dynamic programming problem, instructions for until a stopping criterion is met: determining at least one linear programming problem for the dynamic programming problem, providing the at least one linear programming problem to a quantum computer comprising the generated at least one oracle to determine at least one solution, obtaining the determined at least one solution, and providing the determined at least one solution; and instructions for providing a solution to the dynamic programming problem.

### BRIEF DESCRIPTION OF THE FIGURES

In the following description of one or more embodiments, references to the accompanying drawings are by way of illustration of an example by which the invention may be practiced.

FIG. 1 is a flowchart which shows an embodiment of a method for solving a dynamic programming problem using a quantum computer.

FIG. 2 is a diagram which shows an embodiment of a system in which an embodiment of the method for solving a dynamic programming problem may be used.

### DETAILED DESCRIPTION OF THE INVENTION

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an,” “the” and “at least one” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “i.e.” and like terms mean “that is,” and thus limit the terms or phrases they explain.

Where values are described as ranges, it will be understood by the skilled addressee that such disclosure includes the disclosure of all possible sub-ranges within such ranges, as well as specific numerical values that fall within such ranges irrespective of whether a specific numerical value or specific sub-range is expressly stated.

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be used, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein

As used herein, the term “classical,” as used in the context of computing or computation, generally refers to computation performed using binary values using discrete bits without use of quantum mechanical superposition and quantum mechanical entanglement. A classical computer may be a digital computer, such as a computer employing discrete bits (e.g., 0's and 1's) without use of quantum mechanical superposition and quantum mechanical entanglement.

As used herein, the term “non-classical,” as used in the context of computing or computation, generally refers to any method or system for performing computational procedures outside of the paradigm of classical computing.

As used herein, the term “physics-inspired,” as used in the context of computing or computation, generally refers to any method or system for performing computational procedures which is based and/or mimics at least in part on any physics phenomenon.

As used herein, the term “quantum device” generally refers to any device or system to perform computations using any quantum mechanical phenomenon such as quantum mechanical superposition and quantum mechanical entanglement.

As used herein, the terms “quantum computation,” “quantum procedure,” “quantum operation,” and “quantum computer” generally refer to any method or system for performing computations using quantum mechanical operations (such as unitary transformations or completely positive trace-preserving (CPTP) maps on quantum channels) on a Hilbert space represented by a quantum device.

As used herein, the term “quantum computer simulator” generally refers to any computer-implemented method using any classical hardware providing solutions to computational tasks mimicking the results provided by a quantum computer.

As used herein, the term “physics-inspired computer simulator” generally refers to any computer-implemented method using any classical hardware providing solutions to computational tasks mimicking the results provided by a physics-inspired computer.

As used herein, the term “Noisy Intermediate-Scale Quantum device” (NISQ) generally refers to any quantum device which is able to perform tasks which surpass the capabilities of today's classical digital computers.

### Definitions

A linear programming problem is an optimization problem with respect to a set of variables.

A linear programming problem may consist of a linear objective function in the variables. A linear programming problem may consist of at least one linear equality constraint. A linear programming problem may consist of at least one linear inequality constraint.

In the embodiment where the linear programming problem consists of no objective function, the linear programming problem is called a feasibility problem.

In most generality, a dynamic programming problem is defined by a finite set of states S and a finite set of possible actions (decisions) A at each state. Performing an action at a given state results in a cost or a reward and a transition to a new state. The optimization problem is to minimize the cost or maximize the reward in a finite number of future steps. As such, dynamic programming is a framework for solving temporal decision-making problems.

Neither the Title nor the Abstract is to be taken as limiting in any way as the scope of the disclosed invention(s). The title of the present application and headings of sections provided in the present application are for convenience only and are not to be taken as limiting the disclosure in any way.

Numerous embodiments are described in the present application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

It will be appreciated that one or more embodiments of the invention may be implemented in numerous ways. In this specification, these implementations, or any other form that the invention may take, may be referred to as systems or techniques. A component, such as a processing device or a memory described as being configured to perform a task, includes either a general component that is temporarily configured to perform the task at a given time or a specific component that is manufactured to perform the task.

With all this in mind, one or more embodiments of the present invention is directed to a method and a system for solving a dynamic programming problem using a quantum computer.

It will be appreciated that a dynamic programming problem may consider a finite or an infinite horizon of accumulative future reward.

In fact, in one or more embodiments, the decision horizon is finite. In such embodiments, the cumulative future reward is a summation of the instantaneous rewards. The optimization problem is to maximize the expected value of the cumulative future reward.

In one or more other embodiments, the decision horizon is infinite. In one or more embodiments, the cumulative future reward is a discounted summation of the instantaneous rewards. In such embodiments, the dynamic programming problem is called a discounted-reward Markov decision problem.

In one or more other embodiments wherein the decision horizon is infinite, the cumulative future reward may be an average over the instantaneous rewards. In such embodiments, the dynamic programming problem is called an average-reward Markov decision problem.

It will be therefore appreciated that a Markov decision problem (MDP) is either of a discounted-reward or average-reward Markov decision problem.

Markov decision problems generalize dynamic programming to infinite horizon scenarios. The most important modification is the introduction of a discount factor that results a well-defined cumulative reward function known as the value function for the optimization problem. An alternative to introducing a discount factor is optimization of an average reward function. A Markov decision problem seeks an optimal solution for a stochastic process called the Markov decision process. Markov decision processes are similar to Markov chains as far as the Markovian property of the stochastic process is concerned but are different in the fact that the transition kernels of them not only depend on the current state s∈S of the system, but on the action a∈A.

In one or more embodiments of the method disclosed herein, a linear programming (LP) formulation for the dynamic programming problem is constructed, then the dual linear programming (LP) is obtained and then a feasibility problem is constructed from it. A meta-algorithm, known as the multiplicative weight update method (MWUM), is used on the feasibility problem. The multiplicative weight update method in turn creates simpler LPs defined on a simplex. A quantum minimum finding algorithm (See Durr, Christoph, and Peter Hoyer. 1996. “A Quantum Algorithm for Finding the Minimum.” arXiv Preprint Quant-Ph/9607014) is then used to solve them.

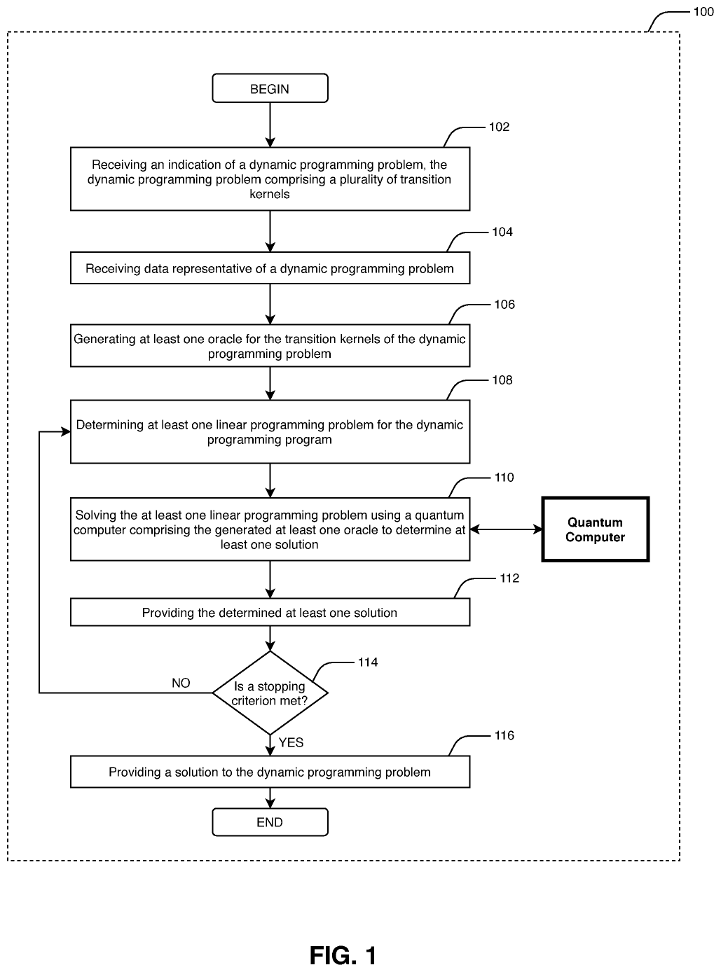

Now referring to FIG. 1, there is shown an embodiment of a method for solving a dynamic programming problem using a quantum computer.

According to processing step 102, an indication of a dynamic programming problem is received. The dynamic programming problem comprises a plurality of transition kernels.

It will be appreciated that in one or more embodiments, this processing step comprises obtaining a placeholder for data representative of the dynamic programming problem, the initial state, and the optimal action of the initial state

In one or more embodiments, the dynamic programming problem is a finite horizon dynamic programming problem.

In one or more embodiments, the dynamic programming problem is a Markov decision problem. In one or more embodiments, the Markov decision problem comprises an infinite horizon discounted-reward Marking decision problem. In one or more other embodiments, the Markov decision problem comprises an infinite horizon average-reward Markov decision problem.

Still referring to FIG. 1 and according to processing step 104, data representative of the dynamic programming problem is received. It will be appreciated that the data representative of the dynamic programming problem may be of various types.

It will be appreciated that in one or more embodiments, the data representative of the dynamic programming problem comprises an initial starting state selected from a plurality of all states of the dynamic programming model.

It will be appreciated that in one or more embodiments, the data representative of the dynamic programming problem comprises a finite set of rules describing all allowed transitions of the dynamic programming model from any state to all possible accessible next states.

Still referring to FIG. 1 and according to processing step 106, at least one oracle is generated for the transition kernels of the dynamic programming problem.

It will be appreciated that the at least one oracle may be generated for the transition kernels of the dynamic programming problem according to various embodiments as illustrated herein below.

Still referring to FIG. 1 and according to processing step 108, at least one linear programming problem is determined for the dynamic programming problem.

It will be appreciated that the at least one linear programming problem may be determined according to various embodiments as illustrated herein below.

According to processing step 110, the at least one linear programming problem is solved using a quantum computer. It will be appreciated that the at least one linear programming problem is solved using a quantum computer comprising the generated at least one oracle to determine at least one solution.

In one or more embodiments, the solving of the at least one linear programming problem using a quantum computer comprises performing a multiplicative weight update method on the determined at least one linear programming problem.

It will be appreciated that the performing of the multiplicative weight update method on the determined at least one linear programming problem comprises solving a second set of linear programming problems. The second set of linear programming problems is comprised of linear programming feasibility problems. In one or more embodiments, each of the linear programming feasibility problems in a set of linear programming feasibility problems is solved using a quantum minimum finding algorithm on the quantum computer.

According to processing step 112, the determined at least one solution is provided.

According to processing step 114, a test is performed in order to find out if a stopping criterion is met.

It will be appreciated that the stopping criterion may be of various types. In one embodiment, the stopping criterion is that the convergence of the determined at least one solution is detected. In another embodiment, the stopping criteria is that a certain amount of wall-clock has passed. In an alternative embodiment, the stopping criterion that the solution to the problem has not improved more than a sensitivity threshold of recent iterations of the loop. In another embodiment, the stopping criterion is that the optimal action inferred from the solution has not changes in the past certain window of recent iterations. In another embodiment, the stopping criterion is that the number of iterations reached a given predetermined number. In the embodiment wherein the finite horizon Dynamic Programming problem is to be solved the predetermined number of iterations may be based on Proposition 4 or Proposition 5. In the embodiment wherein the Markov Decision Problem is to be solved the predetermined number of iterations may be based on Proposition 5 or Proposition 6. In the embodiment wherein the deterministic Markov Decision Problem is to be solved the predetermined number of iterations may be based on Proposition 7. In the embodiment wherein the non-deterministic Markov Decision Problem is to be solved the predetermined number of iterations may be based on Proposition 8.

In the case where the stopping criterion is not met, processing steps 108, 110 and 112 are performed.

In the case where the stopping criterion is met and according to processing step 116, a solution to the dynamic programming problem is provided.

It will be appreciated that the solution to the dynamic programming problem may be of various types.

For instance, and in accordance with one or more embodiments, the solution to the dynamic programming problem comprises an optimal value function at the initial starting state. In one or more embodiments, the solution to the dynamic programming problem comprises an optimal policy at the initial starting state.

It will be appreciated that one or more embodiments of the method disclosed herein may be used for solving a multi-period optimization problem

In one or more embodiment, the multi-period optimization problem comprises at least one of a dynamic portfolio problem, an optimal growth problem and a shortest path problem.

It will be appreciated that one or more embodiments of the method disclosed herein may be used for solving an optimal control problem. The optimal control deals with the problem of finding a control law for a given system such that a certain optimality criterion is achieved.

In one or more embodiments, the optimal control problem comprises at least one member of a group consisting of a dynamic portfolio problem, an optimal growth problem, and a shortest path problem.

### Advantages of One or More Embodiments of the Method Disclosed Herein

One or more embodiments of the method disclosed herein have the advantage that they achieve an improved performance for solving a dynamic programming problem (of DP or MDP types).

In some embodiments the quantum algorithm is implemented on a circuit-model quantum computer with native instructions selected from a finite universal gate set. In one embodiment, the universal gate set is the Clifford+T gate set. In another embodiment, the universal gate set is the Hadamard+R_{π/B}^{Z}+CNOT gate set. The method achieves a computational complexity advantage over all possible classical methods run on a classical (digital) computer.

Another advantage of one or more embodiments of the method disclosed herein is that they enable using a quantum computer for solving a dynamic programming problem of DP or MDP types.

Another advantage of one or more embodiments of the method disclosed herein is that they extend the quantum computer functionality to solving a dynamic programming problem of DP or MDP types.

Another advantage of one or more embodiments of the method disclosed herein is that they enable using various types of quantum devices for solving a dynamic programming problem of DP or MDP types.

### Embodiments for Providing Data Representative of the Dynamic Programming Problem to a Quantum Computer

In one or more embodiments, the quantum computer is a circuit model quantum computer. In those embodiments, the data representative of the dynamic programming problem may be provided to the quantum processing unit using either of several possible methods.

In one or more embodiments, the dynamic programming problem consists of deterministic transitions between the states and the oracle to which coherent queries are made is:

|s [symbol] |a [symbol] |x [symbol] [symbol] |s [symbol] |a [symbol] |x⊕a(s) [symbol] .

In the case where the effect of taking actions at the states of the dynamic programming problem is non-deterministic, the oracle queried to may be described via

|s [symbol] |a [symbol] |s′ [symbol] |x [symbol] [symbol] |s [symbol] |a [symbol] |s′ [symbol] |⊕p(s′|s,a) [symbol] .

In one or more embodiments, the quantum computer is a system for solving optimization problems.

In one or more embodiments, the quantum computer is a quantum annealer.

In one or more embodiments, the quantum computer is a coherent Ising machine comprising a network of optic parametric oscillators.

In these embodiments, the data representative of the dynamic programming problem may be stored in a classical (digital) storing device as classical functions.

Queries to the classical functions in the deterministic dynamic programming problems are of the form

(s,a) [symbol] a(s)

and in the non-deterministic dynamic programming problems of the form

(s,a,s′) [symbol] p(s′|s,a).

In these embodiments, the quantum processing units are used for solving the optimization problems.

### Multiplicative Weight Update Method

Kale, Satyen. 2007. Efficient Algorithms Using the Multiplicative Weights Update Method. Princeton University (hereinafter Kale et al.), which is incorporated herein by reference, discloses an introduction to the Multiplicative Weight Update method (hereinafter the MW method).

Following Kale et al. a general setting is first described.

Given n experts and T iterations, every expert recommends a course of action. Decisions are expected to be made based on experts' recommendations and the cost of each action. In the early iterations, the nave strategy is to pick an expert at random. The expected cost will be that of the “average” expert. In later iterations, it may be observed that some experts clearly outperform others. It may be chosen to reward those experts by increasing the probability of their selection in the next rounds. As will be apparent in what follows, this revision of strategy is exactly the multiplicative weight update rule.

Let p^{(t)} be the distribution from which the experts are selected at iteration t≤T. Expert i∈{1, . . . , n} is now selected according to this distribution. At this point, the costs of the actions recommended by the experts are obtained from the environment in the form of a vector m^{(t)}. It is assumed that all entries of m^{(t)} are in the range [−1,1].

The multiplicative update algorithm is as follows. Given ϵ≤½ and starting at step t=1 and w^{(t)}:=1 and for steps t=1, 2, . . . , T the following processing steps are performed:
a. Expert i is chosen with probability proportional to her weight; i.e., with probability

$${p}_{i}^{( t )} = \frac{{w}_{i}^{( t )}}{{Σ}_{i} {w}_{i}^{( t )}} .$$

b. The t-th iteration cost vector m^{(t)} is obtained.
c. The selection weights of experts is updated via wᵢ^{(t+1)}=wᵢ^{(t)}(1−ϵmᵢ^{(t)})

For every expert i, the above algorithm guarantees that after T iterations:

$${\sum }_{t = 1}^{T} {m}^{( t )} \cdot {p}^{( t )} \leq {\sum }_{t = 1}^{T} {m}_{i}^{( t )} + ɛ {\sum }_{t = 1}^{T} \vert {m}_{i}^{( t )} \vert + \frac{ln n}{ɛ} .$$

It will be appreciated that solving linear feasibility problem is the application of interest in the MW method.

Let [symbol] be a convex set in [symbol] ⁿ, A be an s×n matrix, and x∈ [symbol] ⁿ. The feasibility of the following convex program is checked:

Ax≥b

s.t. x∈ [symbol] . Equation 1

Letting Aᵢ be the i-th row of A, bᵢ the i-th entry of b, and δ>0 an error parameter, an algorithm is designed which either solves the problem to an additive error of δ, i.e., finds and x∈ [symbol] such that for all i,

Aᵢx≥bᵢ−δ

or proves that the system is infeasible. It is also assumed that there exists an algorithm Q which is treated as an oracle that given a probability distribution vector p on the s constriants, solves the following feasibility problem:

p^{T}Ax≥p^{T}b

s.t.x∈ [symbol] . Equation 2

The feasibility problem Equation 2 is a Lagrangian relaxation of Equation 1 and it may be found easier to solve in certain situations. In particular, a solution x* for Equation 1 satisfies Equation 2 for every choice of probability distribution p. Equivalently, a probability distribution p for which Equation 2 is infeasible is a proof that the original problem Equation 1 is not feasible.

Let [symbol] ≥0 be a bound on the absolute value of all slacks in Equation 1. That is

Aᵢx−bᵢ∈[− [symbol] , [symbol] ] for all i.

A slight simplification of (See Theorem 5 of Kale et al.) follows.

Proposition 1. Let δ>0 be a given error parameter. Assume that

$$𝓁 \geq \frac{δ}{2} .$$

Then there is an algorithm which either solves the problem up to an additive error of δ, or correctly concludes that the system is infeasible, making only

$$𝒪 ( \frac{{𝓁}^{2} log ( s )}{{δ}^{2}} )$$

calls to an oracle Q, with an additional processing time of [symbol] (s) per call.

In the use case of the MW method, the oracle Q is a quantum algorithm that efficiently solves the Lagrange relaxation Equation 2. In fact, the quantum algorithm can only solve the feasibility problem up to a precision. Therefore, a variant of Proposition 1 for approximate oracles is useful and proven as (See Theorem 7 of Kale 2007).

The oracle Q is called to be δ-approximate if it solves the feasibility problem Equation 2 up to an additive error δ. That is, given the probability distribution p it either finds x∈ [symbol] such that p^{T}Ax≥p^{T}b−δ or it declares correctly that Equation 2 is infeasible.

Proposition 2. Let δ>0 be a given precision parameter. Assume that

$$𝓁 \geq \frac{δ}{3} .$$

Then there is an algorithm which either solves the problem up to an additive error of δ, or correctly concludes that the system is infeasible, making only

$$𝒪 ( \frac{{𝓁}^{2} log ( s )}{{δ}^{2}} )$$

calls to a δ-approximate oracle Q, with an additional processing time of [symbol] (s) per call.

The dynamic programming (DP) problem is solved using MWUM. In this case the value function to optimize is

$$V ( π , s ) = {V}_{0} ( π , s ) = {\sum }_{i = 0}^{T} r ( {s}_{i} , {a}_{i} )$$

Here T is the time horizon of the dynamic programming (DP) problem and the following structure is given:
1. S and A are finite sets. The transition kernel or law of motion is aₜ:S→S,
2. All rewards are deterministic, possibly time inhomogeneous and for simplicity natural numbers

rₜ=rₜ(s,a):S×A→ [symbol] , ∀t<T,
bounded by an upper bound we denote by an integer [r]>0. Note that a lower bound of 1 for all instantaneous rewards can also be assumed by a constant shift of all rewards if necessary.

All actions are assumed to be admissible at all states. This can be achieved without loss of generality by letting inadmissible action a at state s map this state to null states additionally defined. The accessibility, a, of the dynamic programming (DP) problem is defined as the size of the largest set:

{(a,s):a(s)=s₀},

over all choices of S₀∈S. The dynamic programming (DP) problem is said to have low accessibility if a=0(|A|). This is true for example in the games by Atari, Inc where each state of the game can be achieved only from ‘nearby’ states.

Bellman's optimality criteria for the value function states that an optimal policy πₜ*:S→A is associated to the (unique) optimal value function Vₜ*(s)=Vₜ(πₜ*,s) satisfying

$${V}_{t}^{*} ( s ) = {max}_{a} \{ {r}_{t} ( s , a ) + {V}_{t + 1}^{*} ( a ( s ) ) \} ∀ t < T$$

an LP can be written for this.

$$\begin{matrix}min & {\sum }_{s , t} {v}_{s , t} \\ s . t . & {v}_{s , t} \geq {r}_{s , a , t} + {v}_{a ( s ) , t + 1} ∀ a ∈ A , s ∈ S , t ∈ \{ 0 , … , T - 1 \}\end{matrix} \qquad Equation 3$$

Once this is solved, the optimal policy is extracted by solving

$${π}_{t}^{*} ( s ) ∈ {argmax}_{a ∈ A} {v}_{a ( {s}_{t} ) , t} ∀ t < T$$

for every state s.

The above LP is feasible.

All optimal values are integer and bounded by (T−t)┌r┐ at time t. The total sum Σv_{s,t} is bounded by

$$\vert S \vert ( \begin{matrix}T \\ 2\end{matrix} ) ⌈ r ⌉ .$$

### Dual Formulation

The above upper bound for the objective function would become an issue when solving the LP using the MW method. We instead start from a marked state s₀ and solve the LP only to find the optimal vale function at that point. This automatically finds the optimal value function at all states admissible from s as well and in particular will find the optimal action in Equation 3 at s₀ and all admissible states from s₀.

min vₛ_{₀}_{,0}

s.t. v_{s,t}≥r_{s,a,t}+v_{a(s),t+}1 ∀a∈A,s∈S,t∈{0, . . . ,T−1} Equation 4

An attempt at doing a line search on the optimal values of the objective above may be performed. This will require solving the following feasibility problem:

vₛ_{_{0,0}}=σ

v_{s,t}−r_{s,a,t}−v_{a(s),t+1}≥0 ∀s∈S,a∈A,t∈{0, . . . ,T−1}

v_{s,t}≥0 ∀s∈S,t∈{0, . . . ,T−1},

which does not appear easy using a quantum algorithm. Instead the linear programming dual of Equation 4 is formed. It is recalled that the dual of an LP

max(c^{T}x:Ax≤b,x≥0), is min(b^{T}y:A^{T}y≥c,y≥0).

Equation 4 can then be rewritten as

$$max { \sum }_{\underline{s} , \underline{t}} ( - {δ}_{\underline{s} , {s}_{0}} {δ}_{\underline{t} , 0} ) {v}_{\underline{s} , \underline{t}}$$

$$s . t . {\sum }_{\underline{s} , \underline{t}} ( - {δ}_{\underline{s} , s} {δ}_{\underline{t} , t} + {δ}_{\underline{s} , a ( s )} {δ}_{\underline{t} , t + 1} ) {v}_{\underline{s} , \underline{t}} \leq - {r}_{s , a , t} ∀ a ∈ A , \\ s ∈ S , t ∈ \{ 0 , … , T - 1 \}$$

The dual variables are indexed by the constraints and they are denoted by λ_{s,a,t}.

$$\begin{matrix}min & {\sum }_{s , a , t} ( - {r}_{s , a , t} {λ}_{s , a , t} ) \\ s . t . & {\sum }_{s , a , t} ( - {δ}_{\underline{s} , s} {δ}_{\underline{t} , t} + {δ}_{\underline{s} , a ( s )} {δ}_{\underline{t} , t + 1} ) {λ}_{s , a , t} \geq - {δ}_{\underline{s} , {s}_{0}} {δ}_{\underline{t} , 0} ∀ \underline{s} ∈ S , \underline{t} ∈ \{ 0 , … , T - 1 \}\end{matrix}$$

which can be simplified to

$$\begin{matrix}max & {\sum }_{s , a , t} {r}_{s , a , t} {λ}_{s , a , t} \\ s . t . & 1 - {\sum }_{a} {λ}_{{s}_{0} , a , 0} \geq 0 \\ & - {\sum }_{a} {λ}_{\underline{s} , a , \underline{t}} + {\sum }_{{s , a}_{a ( s ) = \underline{s}}} {λ}_{s , a , \underline{t} - 1} \geq 0 ∀ \underline{s} ∈ S , \underline{t} ∈ \{ 1 , … , T - 1 \}\end{matrix} \qquad Equation 5$$

By strong duality the optimal value of Equation 5 coincides with that of Equation 4. So, a line search may be performed on [1,T[r]] in pursuit of the optimal objective value of Equation 5. For a given σ∈[1,T┌r┐] the feasibility problem is solved

$$1 - {\sum }_{a} {λ}_{{s}_{0} , a , 0} \geq 0 \\ - {\sum }_{a} {λ}_{\underline{s} , a , \underline{t}} + {\sum }_{{s , a}_{a ( s ) = \underline{s}}} {λ}_{s , a , \underline{t} - 1} \geq 0 ∀ \underline{s} ∈ S , \underline{t} ∈ \{ 1 , … , T - 1 \}$$

$${λ}_{s , a , t} ∈ 𝒫$$

where the convex set [symbol] is the simplex cut out in the non-negative orthant by Σ_{s,a,t} r_{s,a,t}λ_{s,a,t}=σ.

### Embodiment for Using the MW Method

In order to perform the multiplicative weight update method to this problem, the following Lagrangian relaxation is formed given a choice of Lagrange multipliers w=(w_{s,t}):

$$\begin{matrix}max & {w}_{{s}_{0} , 0} ( 1 - {\sum }_{a} {λ}_{{s}_{0} , a , 0} ) + {\sum }_{\underline{s} , \underline{t}} {w}_{\underline{s} , \underline{t}} ( - {\sum }_{a} {λ}_{\underline{s} , a , \underline{t}} + {\sum }_{{s , a}_{a ( s ) = \underline{s}}} {λ}_{s , a , \underline{t} - 1} ) \\ s . t . & {λ}_{s , a , t} ∈ 𝒫 \end{matrix} \qquad Equation 6$$

To find a feasible solution for the MW method iterations, it suffices to show that the maximum value of the above linear program is positive. By the fundamental theorem of linear programming we only need to check the external points of the simplex Σ_{s,a,t}r_{s,a,t}λ_{s,a,t}=σ to find a maximizer. These solutions are of the form (0, . . . , σ/r_{s,a,t}, . . . , 0) for a choice of tuple (s,a,t). So if there is an access to an oracle for the function

$$\begin{matrix}{f}_{σ , w} \text{:} ( \overline{s} , \overline{a} , \overline{t} ) ↦ & {w}_{{s}_{0} , 0} ( 1 - {\sum }_{a} \frac{σ {\overline{δ}}_{{s}_{0} , a , 0}}{{r}_{{s}_{0} , a , 0}} ) + \\ & {\sum }_{\underline{s} , \underline{t}} {w}_{\underline{s} , \underline{t}} ( - {\sum }_{a} \frac{σ {\overline{δ}}_{\underline{s} , a , \underline{t}}}{{r}_{\underline{s} , a , \underline{t}}} + {\sum }_{{s , a}_{a ( s ) = \underline{s}}} \frac{σ {\overline{δ}}_{s , a , \underline{t} - 1}}{{r}_{s , a , \underline{t} - 1}} ) \\ = & {w}_{{s}_{0} , 0} - σ {w}_{{s}_{0} , 0} \frac{{δ}_{\overline{s} , {s}_{0}} {δ}_{\overline{t} , 0}}{{r}_{{s}_{0} , \overline{a} , 0}} - σ {w}_{\overline{s} , \overline{t}} \frac{1}{{r}_{\overline{s} , \overline{a} , \overline{t}}} + σ {w}_{\overline{a} ( \overline{s} ) , \overline{t} + 1} \frac{1}{{r}_{\overline{s} , \overline{a} , \overline{t}}} \\ = & {w}_{{s}_{0} , 0} ( 1 - σ \frac{{δ}_{\overline{s} , {s}_{0}} {δ}_{\overline{t} , 0}}{{r}_{{s}_{0} , \overline{a} , 0}} ) + \frac{σ}{{r}_{\overline{s} , \overline{a} , \overline{t}}} ( - {w}_{\overline{s} , \overline{t}} + {w}_{\overline{a} ( \overline{s} ) , \overline{t} + 1} )\end{matrix}$$

Here w_{ā(s̅),t̅+1} term only contributes when t̅<T−1.

Equation 6 can now be solved using quantum minimum finding. If the maximum found is negative (with more than a determined additive error of δ) then the process HALT. Otherwise it is continued with the multiplicative weight update rule.

A unitary is used

U_{σ,w}^{δ}:|s [symbol] |a [symbol] |x [symbol] [symbol] |s [symbol] |a [symbol] |t [symbol] |x⊕ƒ_{σ,w}(s,a,t)

[symbol]

implementing the function ƒ_{σ,w} up to an additive error δ>0.

Proposition 3. Let U_{σ,w}^{δ} be a quantum circuit that acts on q qubits and computes ƒ_{σ,w} with precision δ in its binary representation. There exists a quantum algorithm that with O(log(┌ƒ_{σ,w}┐/δ)log(1/p)\sqrt{|S∥A|T}) applications of U_{σ,w}^{δ} and U_{σ,w}^{δ †} and O(q log(┌ƒ_{σ,w}┐/δ)log(1/p)\sqrt{|S∥A|T}) other gates obtains a feasible solution to Equation 6 with success probability at least 1-p up to an additive error δ.

This is proven for instance in (Apeldoorn et al. 2017 Appendix C, Theorem 49 (Apeldoorn, Joran van, András Gilyén, Sander Gribling, and Ronald de Wolf. 2017. “Quantum Sdp-Solvers: Better Upper and Lower Bounds.” In Foundations of Computer Science (Focs), 2017 Ieee 58th Annual Symposium on, 403-14. IEEE.)) as the Generalized Minimum Finding Theorem. The oracle U_{ƒ} uses a register of size log(┌ƒ_{σ,w}┐/δ) to represent ƒ_{σ,w} with precision δ. Each bit of a minimum solution is amplified one at a time starting from the most significant bit.

Proposition 4. Suppose that all iterations of QMF succeed. Then MW method successfully solves the finite horizon DP in O(T²┌r┐²polylog(|S|,|A|,T,┌r┐)) iterations of QMF.

A line search is performed on σ″∈[1,T┌r┐] in O(polylog(T,┌r┐)) iterations. For each choice of σ Equation 6 should be solved with precision ½. So S=½ in the notation of Proposition 2 and QMF provides a δ-approximate oracle for MW method. In the notation of the same theorem [symbol] , the upper bound on slacks in Equation 5, has to be calculated. In the simplex Σ_{s,a,t}r_{s,a,t}λ_{s,a,t}=σ, Σ_{s,a,t}|λ_{s,a,t}|≤σ. Therefore each slack in Equation 5 is bounded by 2σ≤2T┌r┐. The number of variables is |S∥A|T. This all amounts to O(T²┌r┐²polylog(|S|,|A|,T,┌r┐)) iterations.

Of course, QMF only succeeds with a high probability. It will be appreciated that this success probability can be set high enough so that with a high probability all runs of it succeeds throughout the MW method.

Proposition 5. The quantum MW method for solving the finite horizon DP succeeds in

O(\sqrt{|S∥A|}T^{2.5}┌r┐²polylog(|S|,|A|,T,┌r┐))

calls to oracles of QMF and uses q times that number of other gates to succeed with probability at least ½.

If the failure probability of a single iteration of QMF is p O(1/p) runs of it can be made with failure probability of any iteration being at most ½. Also each QMF will perform O(\sqrt{|S∥A|T}polylog(|S|,|A|,T,┌r┌)) calls to its oracles. That is O(\sqrt{ST}polylog(|S|,T,┌r┐) as well. In total this is multiplied with the number of QMFs and the result follows.

### Embodiment for Generating at Least One Oracle

For a given choice of σ∈[1,T┌r┐] and from Proposition 4 M=O(T²┌r┐²polylog(|S|,|A|,T,┌r┐)) many Equation 6 problems have to be solved. Explicitly queries to the following oracle and its conjugate are made:

U_{σ,w}^{δ}:|s [symbol] |a [symbol] |t [symbol] |x [symbol] [symbol] |s [symbol] |a [symbol] |t [symbol] |x⊕ƒ_{σ,w}(s,a,t) [symbol] .

where

$${f}_{σ , w} ( \overline{s} , \overline{a} , \overline{t} ) = {w}_{{s}_{0} , 0} ( 1 - σ \frac{{δ}_{\overline{s} , {s}_{0}} {δ}_{\overline{t} , 0}}{{r}_{{s}_{0} , \overline{a} , 0}} ) + \frac{σ}{{r}_{\overline{s} , \overline{a} , \overline{t}}} ( - {w}_{\overline{s} , \overline{t}} + {w}_{\overline{a} ( \overline{s} ) , \overline{t} + 1} )$$

Here at the k-th iteration of MW method:

w_{s,t}^{k}−(1−εm_{s,t}¹) . . . (1−εm_{s,t}^{k-1})

where for all choices of s∈S, a∈A and k∈{1, . . . t},

$${m}_{\underline{s} , \underline{t}}^{k} = \{ \begin{matrix}1 - {\sum }_{a} {λ}_{{s}_{0} , a , 0}^{k} & \underline{s} = {s}_{0} , \underline{t} = 0 \\ - {\sum }_{a} {λ}_{\underline{s} , a , \underline{t}}^{k} + {\sum }_{{s , a}_{a ( s ) = \underline{s}}} {λ}_{s , a , \underline{t} - 1}^{k} & otherwise . \end{matrix}$$

Here λ_{s,a,t}^{k} is only nonzero if at the k-th iteration the simplex vertex (s^{k},a^{k},t^{k}) was chosen by QMF. In the case where they are nonzero, the values are of the form o^{k}/rₛ_{^{k}}_{,a}_{^{k}}_{,t}_{^{k}} where σ^{k} is the k-th chosen σ in the line search:

$${m}_{\underline{s} , \underline{t}}^{k} = \{ \begin{matrix}1 - {λ}_{{s}_{0} , {a}^{k} , 0}^{k} {δ}_{{s}^{k} , {s}_{0}} {δ}_{{t}^{k} , 0} & \underline{s} = {s}_{0} , \underline{t} = 0 \\ - {λ}_{\underline{s} , {a}^{k} , \underline{t}}^{k} + {λ}_{{s}^{k} , {a}^{k} , \underline{t} - 1}^{k} {δ}_{{a}^{k} ( {s}^{k} ) , \underline{s}} & otherwise . \end{matrix}$$

All this can be implemented with a bounded size quantum circuit, with a bounded number of registers each with number of qubits bounded by log(┌ƒ_{σ,w}┐)=O(polylog(|S|,|A|,|T|,┌r┐)). The number of gates needed to compute w_{s,t}^{k} is in O(T²┌r┐²polylog(|S|,|A|,T,┌r┐)).

There exists a quantum algorithm that solves the finite horizon DP problem with time horizon T using

O(\sqrt{|S∥A|}T^{4.5}┌r┐⁴polylog(|S|,|A|,T,┌r┐))

queries to

|s [symbol] |a [symbol] |x [symbol] [symbol] |s [symbol] |a [symbol] |x⊕a(s)

[symbol]

and same order of other gates.

### Embodiment for Solving Markov Decision Problems

It will be appreciated that infinite horizon dynamic programming problems formulated via discounted-reward Markov decision problems (MDP) are now solved.

A Markov decision process is given by a tuple (S,A,r,p,γ). Here S and A are the sets of states and actions. Both are assumed to be finite. The instantaneous reward function is r:S×A→ [symbol] _{>0}. The transition kernel is p=(pₐ)_{a∈A} where each pₐ is a transition matrix on S and finally γ∈(0,1) is a discount factor.

A policy is a map π:S→A. Restricting the Markov decision process to follow a policy π, will result a Markov chain on S with a transition kernel denoted as p_{π}. The value function of a policy is defined as

$$V ( π , {s}_{0} ) = {\sum }_{i \geq 0} {γ}^{i} {𝔼}_{π} [ r ( {s}_{i} , {a}_{i} ) ] .$$

Bellman's optimality criteria for the value function states that an optimal policy π* is associated to the (unique) optimal value function V*(s)=V(π*,s) satisfying

$${V}^{*} ( s ) = {max}_{a ∈ A} ( r ( s , a ) + γ {\sum }_{s ′ ∈ S} p ( {s}^{′} \vert s , a ) {V}^{*} ( {s}^{′} ) )$$

where p_{π*}(s,s′) is the transition kernel for the Markov chain that results from restriction of the Markov decision process to the policy π*. It is well-known that there exists a unique solution V*:S→ [symbol] satisfying this functional equation.

Without loss of generality, by a shift if necessary, the range of r is bounded by [1,┌r┐]. Then the optimal value function ranges in

$$[ \frac{1}{1 - γ} , \frac{⌈ r ⌉}{1 - γ} ] .$$

It will be appreciated that a policy π is said to be ε-optimal if ∥V*−V^{π}∥_{∞}≤ε.

### Dual Formulation

It will be appreciated that the same approach is followed as previously. Starting with a marked state sₒ an LP can be written

$$\begin{matrix}min & {v}_{{s}_{0}} \\ s . t . & {v}_{s} \geq {r}_{s , a} + γ {\sum }_{s ′ ∈ S} p ( {s}^{′} \vert s , a ) {v}_{s ′} ∀ s ∈ S , a ∈ A\end{matrix} \qquad Equation 7$$

which can be rewritten as

$$\begin{matrix}max & {\sum }_{\underline{s}} ( - {δ}_{\underline{s} , {s}_{0}} ) {v}_{\underline{s}} \\ s . t . & {\sum }_{\underline{s}} ( - {δ}_{\underline{s} , s} + γ p ( \underline{s} \vert s , a ) ) {v}_{\underline{s}} \leq - {r}_{s , a} ∀ a ∈ A , s ∈ S\end{matrix}$$

with its dual

$$\begin{matrix}max & {\sum }_{s , a} {r}_{s , a} {λ}_{s , a} \\ s . t . & {\sum }_{s , a} ( - {δ}_{\underline{s} , s} + γ p ( \underline{s} \vert s , a ) ) {λ}_{s , a} + {δ}_{\underline{s} , {s}_{0}} \geq 0 ∀ \underline{s} ∈ S .\end{matrix} \qquad Equation 8$$

By strong duality the optimal value of Equation 8 coincides with that of Equation 7. So, a line search may be performed on

$$[ \frac{1}{1 - γ} , \frac{⌈ r ⌉}{1 - γ} ]$$

in pursuit of the optimal objective value of Equation 8.

For a given σ∈

$$[ \frac{1}{1 - γ} , \frac{⌈ r ⌉}{1 - γ} ] ,$$

the following feasibility problem is to be solved

$${\sum }_{s , a} ( - {δ}_{\underline{s} , s} + γ p ( \underline{s} \vert s , a ) ) {λ}_{s , a} + {δ}_{\underline{s} , {s}_{0}} \geq 0 ∀ \underline{s} ∈ S . \\ {λ}_{s , a} ∈ 𝒫$$

where the convex set P is the simplex cut out in the non-negative orthant by Σ_{s,a} r_{s,a} λ_{s,a}=σ. Therefore, in order to perform the MW method to this problem, the following Lagrangian relaxation given a choice of Lagrange multipliers w=(wₛ) is formed:

$$\begin{matrix}max & {\sum }_{\underline{s}} {w}_{\underline{s}} ( {\sum }_{s , a} ( - {δ}_{\underline{s} , s} + γ p ( \underline{s} \vert s , a ) ) {λ}_{s , a} + {δ}_{\underline{s} , {s}_{0}} ) \\ s . t . & {λ}_{s , a} ∈ 𝒫 \end{matrix} \qquad Equation 9$$

By the fundamental theorem of linear programming only the external points of the simplex Σ_{s,a}r_{s,a} λ_{s,a}=σ have to be checked to find a maximizer. These solutions are of the form (0, . . . , σ/r_{s,a}, . . . , 0). The largest value obtained on the vertices of the simplex is found using quantum minimum finding (QMD) and to do so oracle calls are made to

$$\begin{matrix}{f}_{σ , w} \text{:} ( \overline{s} , \overline{a} ) ↦ & {\sum }_{\underline{s}} {w}_{\underline{s}} ( {\sum }_{s , a} ( - {δ}_{\underline{s} , s} + γ p ( \underline{s} \vert s , a ) ) {λ}_{s , a} + {δ}_{\underline{s} , {s}_{0}} ) \\ = & {w}_{{s}_{0}} + {λ}_{\overline{s} , \overline{a}} {\sum }_{\underline{s}} {w}_{\underline{s}} ( - {δ}_{\underline{s} , \overline{s}} + γ p ( \underline{s} \vert \overline{s} , \overline{a} ) ) \\ = & {w}_{{s}_{0}} - {λ}_{\overline{s} , \overline{a}} {w}_{\overline{s}} + {γλ}_{\overline{s} , \overline{a}} {\sum }_{\underline{s}} {w}_{\underline{s}} p ( \underline{s} \vert \overline{s} , \overline{a} ) .\end{matrix} \qquad Equation 10$$

That is, the construction of unitaries of the form

U_{σ,w}^{δ}:|s [symbol] |a [symbol] |x [symbol] [symbol] |s [symbol] |a [symbol] |x⊕ƒ_{σ,w}(s,a)

[symbol]

is used, implementing the function ƒ_{σ,w} up to an additive error δ>0 by acting on q qubits. By Proposition 3 there is an algorithm (denoted by QMF) that with O(log(┌ƒ_{σ,w}┐/δ)log(1/p)\sqrt{|S∥A|}) applications of U_{σ,w}^{δ} and U_{σ,w}^{Γ †} and O(q log(┌ƒ_{σ,w}┐/δ)log(1/p)\sqrt{|S∥A|}) other gates obtains a feasible solution to Equation 9 with success probability at least 1−p up to an additive error δ.

Recall the multiplicative weight update method of Proposition 2 for an approximation oracle.

Proposition 6. The quantum MW method successfully finds a δ-approximation of V*(s₀) in

$$O ( \frac{\sqrt{\vert S \vert \vert A \vert} {⌈ r ⌉}^{2}}{{( 1 - γ )}^{2} {δ}^{2}} polylog ( \vert S \vert , \vert A \vert , \frac{1}{1 - γ} , ⌈ r ⌉ , δ ) )$$

calls to oracles of QMF and uses q times that number of other gates to succeed with probability at least ½.

A line search is performed on σ

$$∈ [ \frac{1}{1 - γ} , \frac{⌈ r ⌉}{1 - γ} ]$$

in

$$O ( polylog ( \frac{1}{1 - γ} , ⌈ r ⌉ , δ ) )$$

iterations. In the notation of Proposition 2 the bound l is found on slacks of Equation 8. In the simplex σ_{s,a}r_{s,a} λ_{s,a}=σ we have τ_{s,a,t}|λ_{s,a,t}|≤σ. Therefore, each slack in Equation 5 is bounded by

$$2 σ \leq 2 \frac{1}{1 - γ} ⌈ r ⌉ .$$

The number of variables is |S∥A|. This all amounts to

$$O ( \frac{⌈ r ⌉}{{( 1 - γ )}^{2} {δ}^{2}} polylog ( \vert S \vert , \vert A \vert , \frac{1}{1 - γ} , ⌈ r ⌉ , δ ) )$$

iterations of QMF. Now similar to Proposition 5 it can be observed that to have QMF succeed with high probability in all its iterations only logarithmically more calls to its oracles are needed. Also, each QMF will perform

$$O ( \sqrt{\vert S \vert \vert A \vert} polylog ( \vert S \vert , \vert A \vert , \frac{1}{1 - γ} , ⌈ r ⌉ , δ ) )$$

calls to its oracles.

### Embodiment for Solving the Deterministic Markov Decision Problems

A first case in which finding an oracle for Equation 10 is easy is the case of deterministic Markov decision processes. That is, when the transition kernels are delta functions on a single target state for every state-action pair:

p(s|s,a)=δ_{s,a(s)}.

Here, the effect of action a∈A on the space of states S is written as a function a:S→S which deterministically maps every source state to a single target state. In this scenario, the function Equation 10 simplified to

ƒ_{σ,w}(s,a)=wₛ_{₀}−λ_{s,a}wₛ+γλ_{s,a}wₐ₍ₛ₎.

An oracle

U_{σ,w}^{δ}:|s [symbol] |a [symbol] |x [symbol] [symbol] |s [symbol] |a [symbol] |x⊕ƒ_{σ,w}(s,a)

[symbol]

is then straightforward to construct from an oracle for

|s [symbol] |a [symbol] |x [symbol] [symbol] |s [symbol] |a [symbol] |x⊕a(s)

[symbol]

subject to having access to registers in which the multiplicative weights are computed. The latter also carries through the method as in the previous section. For a given choice of σ and from Proposition 6, the MW method performs

$$O ( \frac{{⌈ r ⌉}^{2}}{{( 1 - γ )}^{2} {δ}^{2}} polylog ( \vert S \vert , \vert A \vert , \frac{1}{1 - γ} , ⌈ r ⌉ , δ ) )$$

iterations. This is bound on the number of updates on the multiplicative weights as well and a bound on the number of gates to compute the k-th weight

wₛ^{k}=(1−εmₛ¹) . . . (1−εmₛ^{k-1}).

where for all choices of s∈S, where

mₛ^{k}=(−δ_{s,s}+γδₐ_{^{k}}₍ₛ_{^{k}}_{),s})λ_{s,a}^{k}δ_{s,s}_{^{k}}+δ_{s,s}_{₀}.

Here λ_{s,a}^{k} is only nonzero if at the k-th iteration the simplex vertex (s^{k},a^{k}) was chosen by QMF. In the case they are nonzero the values are of the form σ^{k}/rₛ_{^{k}}ₐ_{^{k}} where σ^{k} is the k-th chosen σ in the line search.

This can be implemented with a bounded size quantum circuit, with a bounded number of registers each with number of qubits bounded by

$$log ( ⌈ {f}_{σ , w} ⌉ ) = O ( polylog ( \vert S \vert , \vert A \vert , \frac{1}{1 - γ} , ⌈ r ⌉ ) )$$

Proposition 7. For a deterministic Markov decision problem (MDP) with discount factor γ and a marked initial state s₀, there exists a quantum algorithm that with high success probability finds a δ-optimal policy using

$$O ( \sqrt{\vert S \vert \vert A \vert} \frac{{⌈ r ⌉}^{4}}{{{δ}^{4} ( 1 - γ )}^{4}} polylog ( \vert S \vert , \vert A \vert , \frac{1}{1 - γ} , ⌈ r ⌉ , δ ) )$$

queries to

|s [symbol] |a [symbol] |x [symbol] [symbol] |s [symbol] |a [symbol] |x⊕a(s)

[symbol]

and same order of other gates.

### Embodiment for Solving the Non-Deterministic Markov Decision Problems (MDP)

More generally, when the transition kernel p(s′|s,a) is not a delta function, an oracle for the transition probabilities is assumed to be given by

|s [symbol] |a [symbol] |s′ [symbol] |x [symbol] [symbol] |s [symbol] |a [symbol] |s′ [symbol] |x⊕p(s′|s,a) [symbol] .

This enables to construct an oracle for Equation 10 as

U_{σ,w}^{δ}:|s [symbol] |a [symbol] |x [symbol] [symbol] |s [symbol] |a [symbol] |x⊕ƒ_{σ,w}(s,a)

[symbol]

where

$${f}_{σ , w} ( s , a ) = {w}_{{s}_{0}} - {λ}_{s , a} {w}_{s} + γ {λ}_{s , a} {\sum }_{{s}^{′}} {w}_{{s}^{′}} p ( {s}^{′} \vert s , a ) ,$$

subject to having access to registers in which the multiplicative weights are computed. To calculate ƒ_{σ,w} controlled over |s [symbol] and |a [symbol] , wₛ, and p(s′|s,a) controlled over |s′ [symbol] are calculated. Finite arithmetic circuits are then used to prepare the multiplication wₛ,p(s′|s,a). Quantum counting algorithm of Brassard et al. disclosed in Brassard, G, P Hoyer, M Mosca, and A Tapp. 2000. “Quantum Amplitude Amplification and Estimation.” Quantum Computation and Quantum Information: A Millennium Volume. AMS Contemporary Mathematics Series (herein after Brassard et al.) is then used to compute Σₛ,wₛ,p(s′|s,a).

Let S be any discrete set and ƒ:S→ [symbol] be a real-valued function on S. Let

W_{ƒ}:|s [symbol] |x [symbol] [symbol] |s [symbol] |x⊕ƒ(s)

[symbol]

be an oracle for it that using registers with log(┌ƒ┐/δ) qubits coherently calculates ƒ. Then there exists a quantum algorithm that computes Σ_{s∈{0,1}}_{ⁿ} ƒ (s) with precision δ and success probability 1−p using O(|S| log(1/p)log(|S|┌ƒ┐/δ)) queries to W_{ƒ}.

The number of 1s appearing in the k-th significant bit calculated by the oracle W over all choices of points s E S may be counted using the Quantum Counting Theorem (See Theorem 13 of Brassard et al.). According to this theorem with 8πk|S| queries to W, the number of 1s is computed exactly with failure probability

$$1 - \frac{1}{2 ( k - 1 )} .$$

Let k=2 and therefore with O(|S|) queries to W_{ƒ} the number of 1s in the k-th significant bit of the binary representation of ƒ is calculated with probability ½. The Powering Lemma (Lemma 1 disclosed in Montanaro, Ashley. 2015. “Quantum Walk Speedup of Backtracking Algorithms.” arXiv Preprint arXiv:1509.02374) is then invoked which shows that for any p∈(0,1), by log(1/p) repetitions of the above counting subroutine and taking the median of the obtained estimates the probability of success can be boosted to 1−p.

For a given a and from Proposition 6, MW method performs

$$O ( \frac{{⌈ r ⌉}^{2}}{{( 1 - γ )}^{2} {δ}^{2}} polylog ( \vert S \vert , \vert A \vert , \frac{1}{1 - γ} , ⌈ r ⌉ , δ ) )$$

iterations. This is bound on the number of updates on the multiplicative weights and a bound on the number of gates to compute the k-th weight wₖ^{k} c for every s∈S.

There is a quantum circuit implementing the oracle U_{σ,w}^{δ} correctly with probability 1−p using

$$O ( log ( \vert S \vert , \vert A \vert , \frac{1}{1 - γ} , ⌈ r ⌉ ) )$$

qubits and

$$O ( \vert S \vert \frac{{⌈ r ⌉}^{2}}{{( 1 - γ )}^{2} {δ}^{2}} polylog ( \vert S \vert , \vert A \vert , \frac{1}{1 - γ} , ⌈ r ⌉ , δ , \frac{1}{p} ) )$$

gates.

This follows from above and the fact that the real-valued function ƒ_{σ,w} is bounded above by a polynomial of

$$\vert S \vert , \vert A \vert , \frac{1}{1 - γ} ,$$

and ┌r┐. Therefore

$$log ( ⌈ {f}_{σ , w} ⌉ ) = O ( polylog ( \vert S \vert , \vert A \vert , \frac{1}{1 - γ} , ⌈ r ⌉ ) ) .$$

Proposition 8. For a non-deterministic Markov decision problem (MDP) with discount factor γ and a marked initial state s₀, there exists a quantum algorithm that with high success probability finds a δ-optimal policy using

$$O ( {\vert S \vert}^{\frac{3}{2}} {\vert A \vert}^{\frac{1}{2}} \frac{⌈ r ⌉}{{{δ}^{4} ( 1 - γ )}^{4}} polylog ( \vert S \vert , \vert A \vert , \frac{1}{1 - γ} , ⌈ r ⌉ , δ ) )$$

queries to

|s [symbol] |a [symbol] |s′ [symbol] |x [symbol] [symbol] |s [symbol] |a [symbol] |s′ [symbol] |x⊕p(s′|s,a)

[symbol]

and same order of other gates.

It will be appreciated that a non-transitory computer readable storage medium is further disclosed for storing computer-executable instructions which, when executed, cause a computer to perform a method for solving a dynamic programming problem using a quantum computer, the method comprising receiving an indication of a dynamic programming problem, the dynamic programming problem comprising a plurality of transition kernels, receiving data representative of the dynamic programming problem, generating at least one oracle for the transition kernels of the dynamic programming problem, until a stopping criterion is met: determining at least one linear programming problem for the dynamic programming problem, solving the at least one linear programming problem using a quantum computer comprising the generated at least one oracle to determine at least one solution, and providing the determined at least one solution; and providing a solution to the dynamic programming problem.

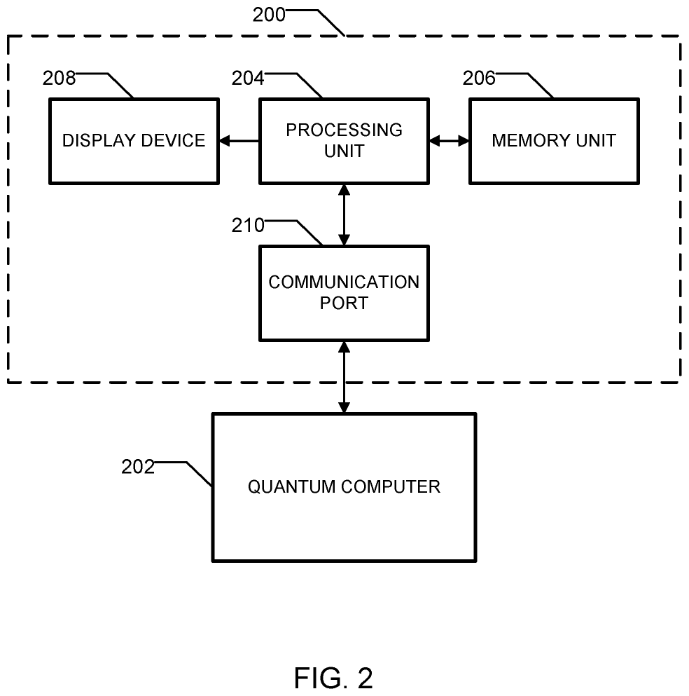

Now referring to FIG. 2, there is shown an embodiment of a system for solving a dynamic programming problem in accordance with one or more embodiments of the method disclosed herein.

The system comprises a digital computer 200 operatively connected to a quantum computer 202.

It will be appreciated that the quantum computer 202 may be of various types as known to the skilled addressee. In one embodiment, the quantum computer 202 comprises superconducting quantum processor, such as a superconducting quantum processor by Rigetti™. In another embodiment, quantum computer 202 comprises an array of superconducting qubits manufactured by Google™.

The digital computer 200 comprises a processing unit 204, a memory unit 206, a display device 208 and a communication port 210. Each of the processing unit 204, the memory unit 206, the display device 208 and the communication port 210 are interconnected via a data bus, not shown.

The processing unit 204 is used for processing data. It will be appreciated that the processing unit 204 may be of various types. In one embodiment, the processing unit 204 comprises AMD™ Ryzen 9 3900X. In another embodiment, the processing unit 204 comprises Intel Core i9-9900KS. In one or more other embodiments, the processing unit 204 comprises at least one member of a group consisting of AMD™ Ryzen 5 2600X, AMD™ Ryzen 3 2200G, AMD™ Ryzen 5 3600X, AMD™ Ryzen 7 1800X, AMD™ Ryzen 7 3700X, Intel™ Core i9-9980XE, Intel™ Pentium G4560 and AMD™ Ryzen 5 2400G.

The memory unit 206 is used for storing data. It will be appreciated that the memory unit 206 may be of various types. In some embodiments, the memory unit 206 comprises one or more physical apparatuses used to store data or programs on a temporary or permanent basis. In one or more embodiments, the memory unit 206 comprises a volatile memory and requires power to maintain stored information. In one or more embodiments, the memory unit 206 comprises a non-volatile memory and retains stored information when the digital computer 200 is not powered. In one or more embodiments, the non-volatile memory comprises a flash memory. In one or more embodiments, the non-volatile memory comprises a dynamic random-access memory (DRAM). In one or more embodiments, the non-volatile memory comprises a ferroelectric random access memory (FRAM). In one or more embodiments, the non-volatile memory comprises a phase-change random access memory (PRAM). In one or more embodiments, the memory unit 206 comprises a storage device including, by way of non-limiting examples, CD-ROMs, DVDs, flash memory devices, magnetic disk drives, magnetic tapes drives, optical disk drives, and cloud computing based storage. In one or more embodiments, the memory unit 206 comprises a combination of devices, such as those disclosed herein.

The communication port 210 is used for enabling at least a communication between the digital computer 200 and another processing device. It will be appreciated that the communication port 210 may be of various types. In one or more embodiments, the communication port 210 is used for connecting the digital computer 200 to the quantum computer 202.

The display device 208 is used for displaying data to a user. It will be appreciated that the display device 208 may be of various types. In one or more embodiments, the display device 208 comprises a cathode ray tube (CRT). In one or more embodiments, the display device 208 comprises a liquid crystal display (LCD). In one or more embodiments, the display device 208 comprises a thin film transistor liquid crystal display (TFT-LCD). In one or more embodiments, the display device 208 comprises an organic light-emitting diode (OLED) display. In one or more embodiments, an OLED display comprises a passive-matrix OLED (PMOLED) or active-matrix OLED (AMOLED) display. In one or more embodiments, the display device 208 comprises a plasma display. In one or more embodiments, the display device 208 comprises a video projector. In one or more embodiments, the display device 208 comprises a combination of devices, such as those disclosed herein.

It will be appreciated that the memory unit 206 is used for storing, inter alia, an application for solving a dynamic programming problem using a quantum computer.

More precisely, the application comprises instructions for receiving an indication of a dynamic programming problem, the dynamic programming problem comprising a plurality of transition kernels. The application further comprises instructions for receiving data representative of the dynamic programming problem. The application further comprises instructions for generating at least one oracle for the transition kernels of the dynamic programming problem. The application further comprises instructions for until a stopping criterion is met: determining at least one linear programming problem for the dynamic programming problem, providing the at least one linear programming problem to a quantum computer comprising the generated at least one oracle to determine at least one solution, obtaining the determined at least one solution and providing the determined at least one solution. The application further comprises instructions for providing a solution to the dynamic programming problem.

1. A method for solving a dynamic programming problem using a quantum computer, the method comprising:
receiving an indication of a dynamic programming problem, the dynamic programming problem comprising a plurality of transition kernels,
receiving data representative of the dynamic programming problem,
generating at least one oracle for the transition kernels of the dynamic programming problem,
until a stopping criterion is met:
determining at least one linear programming problem for the dynamic programming problem,
solving the at least one linear programming problem using a quantum computer comprising the generated at least one oracle to determine at least one solution, and
providing the determined at least one solution; and
providing a solution to the dynamic programming problem.

2. The method as claimed in claim 1, wherein the data representative of the dynamic programming problem comprises an initial starting state selected from a plurality of all states of the dynamic programming model.

3. The method as claimed in claim 2, wherein the solution to the dynamic programming problem comprises the optimal value function at an initial starting state.

4. The method as claimed in claim 2, wherein the solution to the dynamic programming problem comprises an optimal policy at the initial starting state.

5. The method as claimed in claim 1, wherein the data representative of the dynamic programming problem comprises a finite set of rules describing all allowed transitions of the dynamic programming model from any state to all possible accessible next states.

6. The method as claimed in claim 1, wherein the solving of each of the at least one linear programming problems using a quantum computer comprises performing a multiplicative weight update method on the determined at least one linear programming problem.

7. The method as claimed in claim 6, wherein said performing of the multiplicative weight update method on the determined at least one linear programming problem comprises solving a second set of linear programming problems, wherein each of the second set of linear programming problem is generated for solving a given one of the at least one linear programming problem.

8. The method as claimed in claim 7, wherein the second set of linear programming problems is comprised of linear programming feasibility problems.

9. The method as claimed in claim 8, wherein each of the linear programming feasibility problems in a set of linear programming feasibility problems is solved using a quantum minimum finding algorithm on the quantum computer.

10. The method as claimed in claim 1, wherein the quantum computer comprises a circuit model quantum processor.

11. The method as claimed in claim 1, wherein the quantum computer comprises a quantum annealer.

12. The method as claimed in claim 1, wherein the quantum computer comprises a coherent Ising machine comprising a network of optic parametric oscillators.

13. The method as claimed in claim 1, wherein the dynamic programming problem comprises a finite horizon dynamic programming problem.

14. The method as claimed in claim 1, wherein the dynamic programming problem comprises a Markov decision problem.

15. The method as claimed in claim 14, wherein the Markov decision problem comprises an infinite horizon discounted-reward Markov decision problem.

16. The method as claimed in claim 14, wherein the Markov decision problem comprises an infinite horizon average-reward Markov decision problem.

17-20. (canceled)

21. A non-transitory computer readable storage medium is disclosed for storing computer-executable instructions which, when executed, cause a computer to perform a method for solving a dynamic programming problem using a quantum computer, the method comprising:
receiving an indication of a dynamic programming problem, the dynamic programming problem comprising a plurality of transition kernels,
receiving data representative of the dynamic programming problem, generating at least one oracle for the transition kernels of the dynamic programming problem,
until a stopping criterion is met:
determining at least one linear programming problem for the dynamic programming problem,
solving the at least one linear programming problem using a quantum computer comprising the generated at least one oracle to determine at least one solution, and
providing the determined at least one solution; and
providing a solution to the dynamic programming problem.

22. A computer comprising:
a central processing unit;
a display device;
a communication port; and
a memory unit comprising an application for solving a dynamic programming problem using a quantum computer, the application comprising,
instructions for receiving an indication of a dynamic programming problem, the dynamic programming problem comprising a plurality of transition kernels,
instructions for receiving data representative of the dynamic programming problem,
instructions for generating at least one oracle for the transition kernels of the dynamic programming problem,
instructions for until a stopping criterion is met:
determining at least one linear programming problem for the dynamic programming problem,
providing the at least one linear programming problem to a quantum computer comprising the generated at least one oracle to determine at least one solution,
obtaining the determined at least one solution, and
providing the determined at least one solution; and
instructions for providing a solution to the dynamic programming problem.
